(19) United States
(12) Patent Application Publication
(10) Pub. No.: US 2012/0264090 A1
(43) Pub. Date: Oct. 18, 2012

(54) Favored Position Globe

(76) Inventor: Karen Keith, Lorena, TX (US)

(21) Appl. No.: 13/086,906

(22) Filed: Apr. 14, 2011

(51) Int. Cl. G09B 27/08

(52) U.S. Cl. 434/147

(57) ABSTRACT

A favored position globe includes a stand assembly and a frame coupled thereto having an arcuate configuration. First and second axles are mounted along the frame that define an imaginary axis therebetween. A sphere is coupled to the axles so that the sphere is rotatable about the axis, the sphere defining a hollow interior area. A container is positioned in an interior area of the sphere. A processor and memory are positioned in the interior area. A motion sensor is in communication with the processor and positioned to detect rotation of the sphere. A speaker is in communication with the processor and configured to emit sound data stored in the memory. Programming causes the processor to actuate the speaker to emit sound data when the motion sensor detects the sphere is moving. The container defines a weight that causes the sphere to always rest in a predictable position.

### BACKGROUND OF THE INVENTION

This invention relates generally to geographic-type globes and, more particularly, to a globe that is freely rotatable about an axis so as to selectively view portions of geographic indicia printed or otherwise represented on an outer surface thereof. The present invention provides a globe that consistently and predictably comes to rest at a predetermined orientation when not rotating.

Historically, the location and configuration of the Earth's continents, oceans, countries, and other geographical or political designations have been represented on the outer surface of a spherical globe. The globe, or generically referred to herein as a “sphere,” is typically suspended from a frame by axles so that the globe may be freely rotated. In the past, the globe may rest at random orientations when it stops spinning. However, a user may desire that the globe come to rest at an orientation in which a particular geographic location is prominently featured. For example, a user from a particular country or state within a country may desire that his country or state always be visible from a front view when the globe comes to rest.

Various globe devices have been proposed in the art having indicia that draws attention to a predetermined location on a globe's outer surface. For instance, there are globes that represent a particular country or continent in an upward position on the globe or in a manner that over-emphasizes the centrality of the location relatively to the rest of the world. Although assumably effective for their intended purposes, the existing devices do not provide a globe that always comes to rest at a predictable orientation so as to display a particular location to a user. In addition, the existing devices do not draw even more specific attention to the predetermined location by emitting sound data when the globe is spinning.

Therefore, it would be desirable to have a favored position globe that satisfies the shortcomings of the prior devices and proposals.

### SUMMARY OF THE INVENTION

A favored position globe according to the present invention includes a stand assembly and a frame coupled to the stand assembly and having a generally arcuate configuration. First and second axles are mounted along the frame so as to define an imaginary axis therebetween. A sphere is coupled to the axles so that the sphere is rotatable about the axis, the sphere defining a hollow interior area. A container is positioned in an interior area of the sphere. A processor and memory are positioned in the interior area. A motion sensor is in data communication with the processor and positioned in the interior area and configured to determine when the sphere is rotating. A speaker is in communication with the processor and configured to emit sound data stored in the memory. Programming in memory causes the processor to actuate the speaker to emit the sound data when the motion sensor detects the sphere is moving. The container defines a weight that causes the sphere to be at a predictable position when at rest.

Therefore, a general object of this invention is to provide a favored position globe that always comes to rest at a predictable orientation.

Another object of this invention is to provide a favored position globe, as aforesaid, having map indicia on an outer surface that brings attention to a particular geographic location and that predictably comes to rest at an orientation so as to draw attention to that particular geographic location.

Still another object of this invention is to provide a favored position globe, as aforesaid, that actuates predetermined sound data, such as a university fight song, when the globe is rotated.

Yet another object of this invention is to provide a favored position globe, as aforesaid, in which an electronics box positioned within an interior area of the spherical globe provides the weight needed to cause the globe to rest predictably at a predetermined orientation.

A further object of this invention is to provide a favored position globe, as aforesaid, in which the electronics box may be constructed of a weighted material or include an auxiliary weighted object.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a favored position globe according to a preferred embodiment of the present invention;

FIG. 2 is a top view of the favored position globe as in FIG. 1;

FIG. 3 is an elevated perspective side view of the favored position globe as in FIG. 1;

FIG. 4a is an isolated perspective view of an electronics container according to the present invention;

FIG. 4b is a side view of the electronics housing as in FIG. 4a; and

FIG. 5 is a block diagram of the electronics of the present invention.

### DESCRIPTION OF THE PREFERRED EMBODIMENT

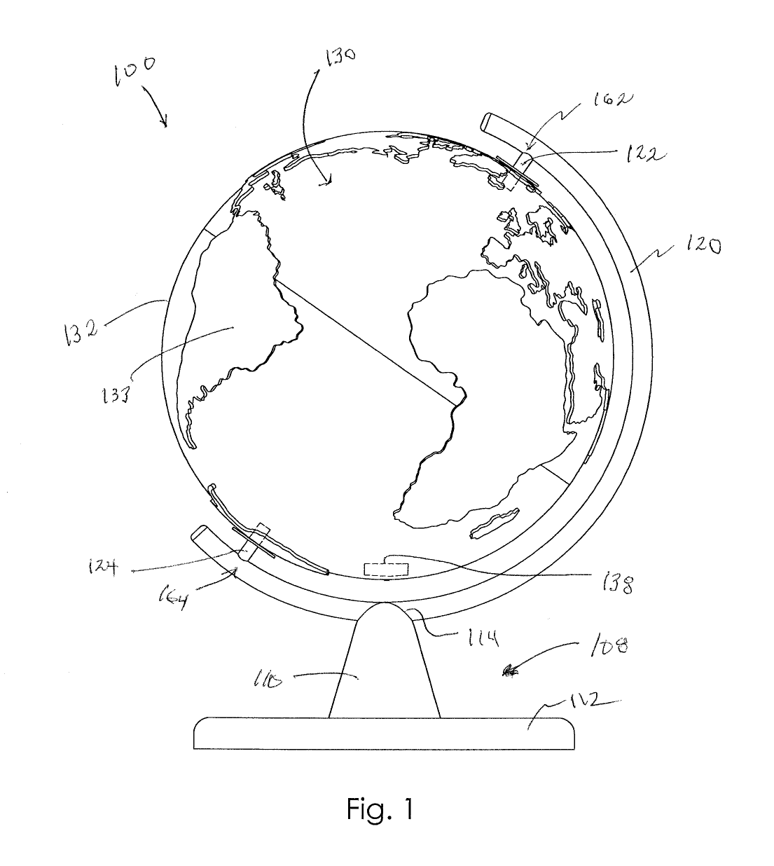

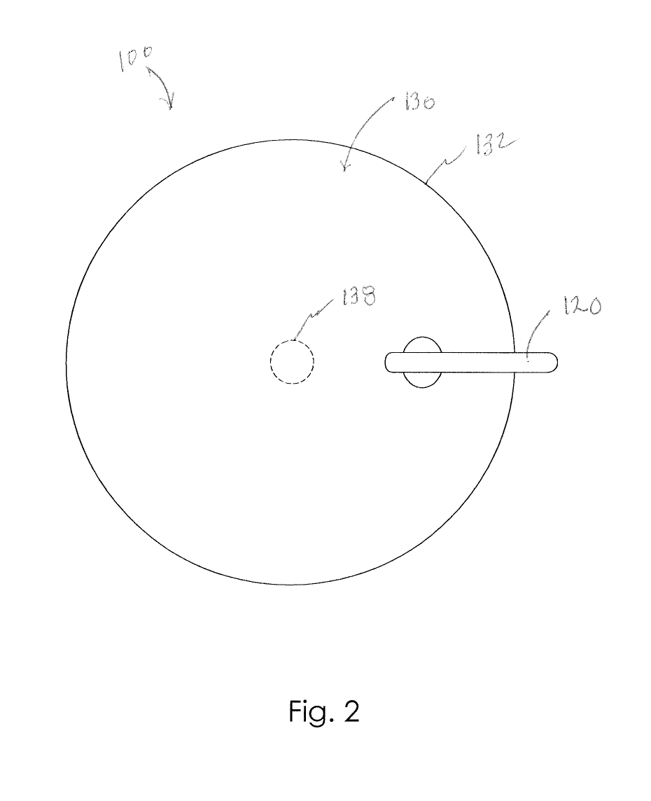

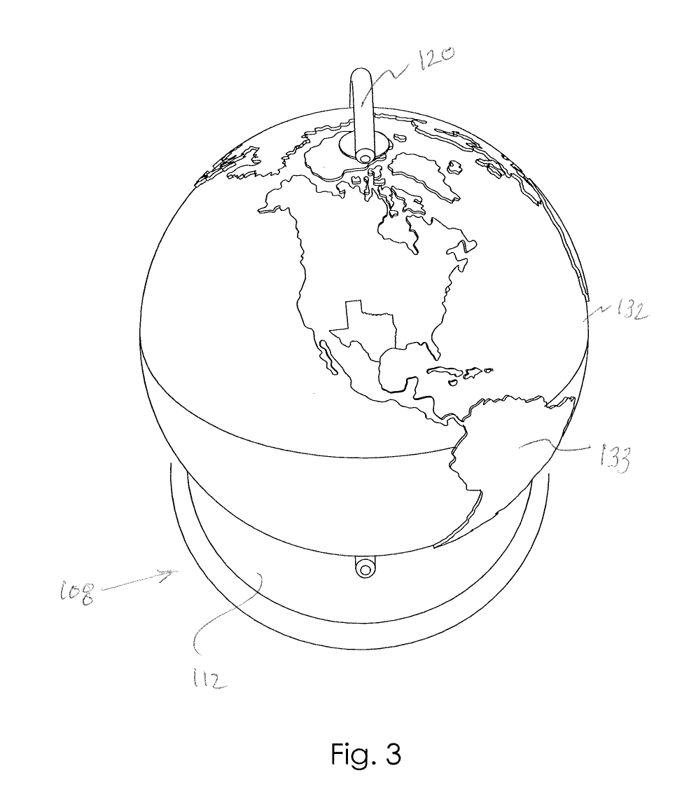

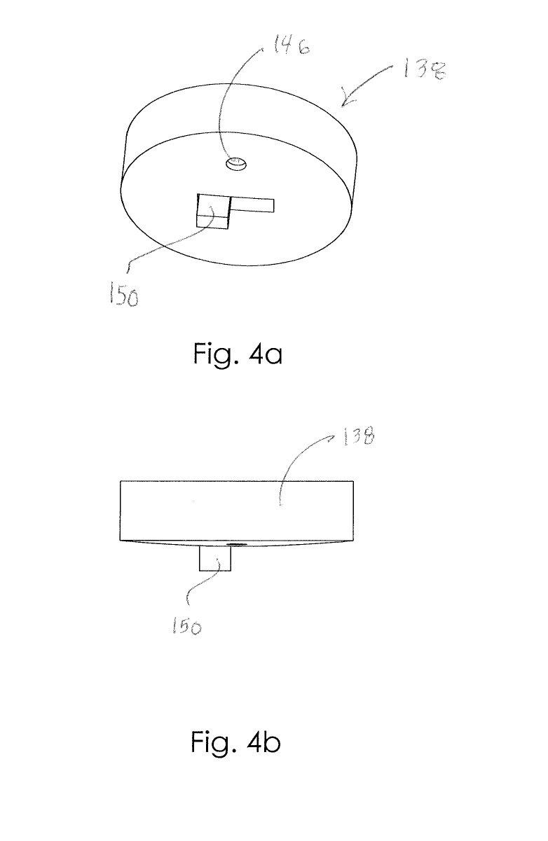

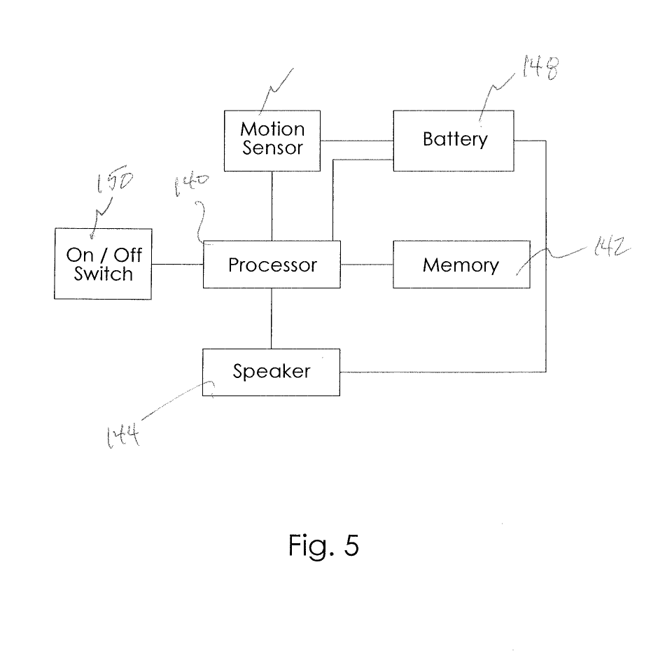

A favored position globe according to a preferred embodiment of the present invention will now be described with reference to FIGS. 1 to 5 of the accompanying drawings. The favored position globe 100 includes a frame 120, a sphere 130 (also referred to herein as a globe) rotatably coupled to the frame 120, a weighted container 138 positioned inside the sphere 130, and electronics configured to emit sound data when the sphere 130 is rotating.

The favored position globe 130 includes a stand assembly 108. The stand assembly 108 includes a base 112 and an elevating pedestal 110. The base 112 includes a generally flat configuration suitable for resting on a generally flat surface, such as a table or cabinet surface. The elevating pedestal 110 is attached to the base 112 and extends upwardly therefrom. The elevating pedestal 110 provides aesthetic appeal to the favored position globe 100 and also includes a slot 114 in which the frame 120 may be secured.

The frame 120 preferably includes a generally arcuate configuration and thus it is curvilinear or generally circular in its curvature. However, the frame 120 need not be completely circular or even be a portion of a perfect circle. The frame 120 may include a first axle point 162 and a second axle point 164. A first axle 122 and a second axle 124 are coupled to an inner surface of the frame 120 at respective axle points 162, 164 and extend away from the frame 120. It is understood that axles are spaced apart from one another and define an imaginary axis extending therebetween.

The globe/sphere 130 is coupled to the first 122 and second 124 axles such that the globe 130 is suspended from the frame 120 and free to rotate/spin about the axis that extends between the axles. The sphere (i.e. the globe) 130 has a generally spherical shape and an exterior surface 132 of which includes indicia 133, such as printing or 3-dimensional features, indicative of at least some of the continents of the Earth's surface. In addition, the exterior surface 132 of the globe may include indicia 133 indicative of particular countries or even states within a country on an accurate or even exaggerated scale. For instance, the state of Texas may be shown on an enlarged scale and the globe configured so that the state of Texas always rests in an upward, forward, or otherwise predictable orientation when the globe is at rest as will be described in more detail below.

The globe/sphere 130 includes an interior surface and defines a generally hollow interior area. It is understood that the frame 120 includes a radius that is slightly larger than a radius of the globe/sphere 130 so that the globe 130 does not contact or interfere with the frame 120 when rotating or spinning about the imaginary axis extending between the axles 122, 124.

A generally hollow container 138 is positioned in the interior area of the globe 130. The container 138 may be constructed of a weighted material such as metal, heavy plastic, or other material such that the container 138 defines a predetermined weight. The container 138 may have a door or openable panel that provides access to its interior space. It is understood that the container 138 may include a weighted object in its interior space, such as sand, metal, stone, or other material that increases the natural weight of the container 138. Alternatively, the weight of electronic components situated in the container 138 may also provide a predetermined weight as will be described more fully below. In addition, it is understood that the container 138 may include either of the weight options discussed above in the alternative or in combination. It is also understood that the globe 130 may be held at rest in a predictable orientation using a magnetic combination. For instance, a magnet (not shown) may be positioned on the frame and a complementary magnetic object may be positioned in the interior area of the globe 130 such that the globe 130 will rest at a predictable orientation when the magnet and complementary magnetic object are attracted firmly to one another.

The container may be fixedly attached to the inner surface of the globe 130 with an adhesive, with a mechanical fastener such as a tack, screw, clasp, or the like, or with a hook and loop fastener combination, or any other fastener suitable for the purpose. The container is fastened to the inner surface of the container 138 at a location that enables the predetermined geographic location indicated on the globe's exterior surface to rest at the predetermined orientation. The weighted container 138 will naturally rest at a bottom position due to the law of gravity. Therefore, the container 138 must be positioned a predetermined distance away from the predetermined geographic location to be prominently displayed when the globe 130 is at rest.

Certain electronic components may be positioned in the container 138. A processor 140 may be positioned in the container 138 along with a memory 142 electrically connected to the processor 140. The memory 142 may include data structures for storing programming instructions executable by the processor 140 and sound data. It is understood that the processor 140 and memory 142 may alternatively be interchanged with specific circuitry configured to perform similar functions as would be known to those of ordinary skill in the art of electronics. The sound data stored in the memory 142 may be songs particularly associated with the predetermined geographic location being featured on the exterior surface of the globe 130, such as national anthem, state song, university fight song, or other suitable melody. In other embodiments (not shown), the processor 140 may be connected to an external source of sound data, such as an mp3 player, computer, or the like using a USB connection such that user-supplied sound data may be stored in memory 142. A battery 148 may also be positioned in the container 138 and electrically connected to the processor 140 and other electronic components.

A speaker 144 is electrically connected to the processor 140 and configured to selectively emit sound data stored in the memory 142. The speaker 144 may be positioned in the container 138 but being positioned on its exterior or at another location in the interior area of the globe 130 may also be suitable. A motion sensor 146 may also be electrically connected to the processor 140 and configured to signal the processor 140 when motion is detected. For instance, the motion sensor 146 may be situated on an exterior surface of the container 138 and its sight directed to a respective axle in that the axle is immovable and the container 130 would move if the globe 130 is rotated. In other words, the axle would appear closer, further away, or appear to move laterally if the globe 130 and thus the container 130 and motion sensor 146 were rotated.

The programming in the memory 142, when executed by the processor, is capable of causing the processor 140 to determine if the motion sensor 146 has detected movement of the globe 130. If the motion sensor 146 detects motion, then the processor 140 will actuate the speaker 144 to emit the predetermined sound data.

In addition, the favored position globe 100 may include an on/off switch 150 coupled to the processor 140. When the on/off switch 150 is activated, such as by pressing a button, switch, or the like, the processor 140 actuates the speaker 144 to emit the sound data.

In use, the globe 130 may be spun in the traditional manner so as to view any desired geographical location around the world which is depicted on the globe's outer surface. When allowed to rotate on its own without any urging by a user, the weight of the container 138 and its position on the interior surface of the globe 130 causes the globe 130 to come to rest at a predetermined and predictable orientation. In addition, the motion sensor 146 detects when the globe 130 is rotated and the speaker 144 is actuated to emit sound data previously stored in memory.

It is understood that while certain forms of this invention have been illustrated and described, it is not limited thereto except insofar as such limitations are included in the following claims and allowable functional equivalents thereof.

1. A favored position globe, comprising:
a stand assembly;
a frame coupled to said stand assembly having a generally arcuate configuration;
a first axle and a second axle attached to an inner surface of said frame and extending away therefrom, said first and second axle being spaced apart from one another so as to define an imaginary axis therebetween;
a sphere coupled to said first and second axles such that said sphere is suspended from said frame and free to rotate about said axis, said sphere having an interior surface and defining a hollow interior area;
a container positioned in said interior area;
a processor situated in said container;
a memory situated in said container and electrically connected to said processor, said memory including predetermined sound data and programming executable by said processor;
a motion sensor in data communication with said processor and positioned in said interior area so as to detect if said sphere is rotating or is at rest;
a speaker electrically connected to said processor for selectively emitting said sound data;
wherein said programming in said memory, when executed by said processor, causes said processor to:
determine if said motion sensor has detected rotation of said sphere;
actuate said speaker to emit said sound data if said motion sensor has detected rotation of said sphere; and
wherein said container defines a predetermined weight and is secured to a particular position on said interior surface of said sphere such that said sphere is at a single predictable orientation when at rest.

2. The favored position globe of claim 1, wherein said container is constructed of a material that defines said predetermined weight.

3. The favored position globe of claim 1 further comprising a weighted object situated in said container so as to define said predetermined weight.

4. The favored position globe of claim 3, wherein said processor, said memory, and said speaker define said predetermined weight.

5. The favored position globe of claim 2, wherein said processor, said memory, and said speaker define said predetermined weight.

6. The favored position globe of claim 1, wherein said processor, said memory, and said speaker define said predetermined weight.

7. The favored position globe of claim 3, wherein said stand assembly includes an elevating pedestal that couples a surface-supporting base to said frame assembly.

8. The favored position globe of claim 3, wherein said weighted object is sand.

9. The favored position globe of claim 3, wherein said weighted object is metal.

10. The favored position globe of claim 3, wherein said sphere includes an exterior surface indicative of at least one continent on the Earth's surface.

11. The favored position globe of claim 4, wherein said sphere includes an exterior surface indicative of at least one continent on the Earth's surface.

12. The favored position globe of claim 1, wherein said container is secured to said interior surface with one of an adhesive and a mechanical fastener.

13. The favored position globe of claim 3, wherein said frame has a radius larger than a radius of said sphere.

14. The favored position globe of claim 1, further comprising:
an on/off switch;
programming in said memory for causing said processor to:
determine if said on/off switch has been activated; and
actuate said speaker to emit said sound data if said on/off switch has been activated.
